(19) United States
(12) Patent Application Publication
(10) Pub. No.: US 2024/0338739 A1
(43) Pub. Date: Oct. 10, 2024

(54) SCALING ECOMMERCE WITH SHORT-FORM VIDEO

(71) Applicant: Loop Now Technologies, Inc., San Mateo, CA (US)

(72) Inventors: Jing Xian Chen, Dublin, CA (US); Nga Lun Helen Lam, Montreal (CA); Ka Ka Ng, Kowloon (HK)

(73) Assignee: Loop Now Technologies, Inc., San Mateo, CA (US)

(21) Appl. No.: 18/630,570

(22) Filed: Apr. 9, 2024

Related U.S. Application Data
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/557,622, filed on Feb. 26, 2024.
(60) Provisional application No. 63/571,732, filed on Mar. 29, 2024.

(51) Int. Cl. G06Q 30/0601

(52) U.S. Cl. CPC G06Q 30/0603; G06Q 30/0633

(57) ABSTRACT

Disclosed embodiments provide techniques for scaling ecommerce with short-form video. A micro-website is created and is associated with a user ID. The user ID corresponds to a social media influencer, an expert in a subject matter, or a celebrity. The micro-website can be managed by a mobile application. Based on the user ID, a pre-approved electronic catalog of products is determined and used to populate the micro-website with one or more products for sale. The micro-website includes one or more short-form videos highlighting products for sale from the electronic catalog. The host of the short-form videos is the influencer, expert, or celebrity corresponding to the user ID. The micro-website includes an ecommerce link to allow fulfilling product orders. The short-form videos include a virtual purchase cart for ecommerce purchases that can be engaged by the user.

### RELATED APPLICATIONS

This application claims the benefit of U.S. provisional patent applications “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, and “Artificial Intelligence Virtual Assistant Using Staged Large Language Models” Ser. No. 63/571,732, filed Mar. 29, 2024.

Each of the foregoing applications is hereby incorporated by reference in its entirety.

### FIELD OF ART

This application relates generally to video editing and more particularly to scaling ecommerce with short-form video.

### BACKGROUND

The history of commerce and trade is as old as humanity itself. The exchange of goods and services for something of value, or for other goods and services, has been one of the basic building blocks of societies across the globe. Transportation of products from one location to another has driven the creation and expansion of trade routes and the development of vehicles to move raw materials to factories and finished goods to market. Storage and warehouse facilities have been built and refined to allow for the stockpiling of materials prior to manufacturing and the protection of market-ready goods prior to sale. Distribution networks have been built to move goods from manufacturers to wholesalers, wholesalers to retailers, and retailers to consumers. Marketing and advertising strategies have been developed to communicate to businesses, governments, and consumers the details of products and services, encouraging them to purchase and make use of their wares. The insurance industry has developed in large part to alleviate the risks involved in all phases of commerce. Transportation, communication, security, and dangers from natural disasters are still common concerns that can be mitigated to some extent through the use of insurance policies and processes. Communications have been extended and enhanced on the basis of commercial requirements. Banking and financial institutions provide funding and aid in capitalizing expansion efforts.

In the earliest days, bartering was used to exchange goods and services for other goods and services that were deemed to be of equal value. This form of trade still occurs every day between individuals and businesses, both formally and informally. In ancient civilizations, livestock became an early medium of exchange, acting as an intermediary instrument for purchasing goods and services. Cattle, goats, and sheep were valued by many disparate cultures and people groups and therefore could be used to purchase other goods and services. Often, there would be a series of discussions to decide the relative value of livestock to other goods or services being purchased. The process of “haggling” to decide on the price of a particular product continues to this day in many cultures and works to foster communication between people with widely different backgrounds.

In the modern age, computer networks and ecommerce have built upon the methods of the past, amplifying and refining the processes and accelerating the rate at which business exchanges are made. Financial instruments have been standardized and secure communications networks are used to purchase goods and services worldwide. Exchange rates are established and, even though they fluctuate, the relative value of currencies can be quickly determined in a few seconds through federal or international services. Transportation networks can quickly move finished goods directly to consumers or businesses in a few days, or in some cases, a few hours. Restaurants in metropolitan areas can ship meals to homes or offices in minutes using specialized delivery services. Computer applications are downloaded directly to computers and mobile devices in seconds. Purchases can be made with credit cards or a tap from a mobile phone. While our technology has increased the speed at which business is conducted, the basic processes required to exchange goods and services have not changed. A medium of exchange is still required, with a mutually agreed upon value assigned to it by all parties. Whether the medium is US dollars, gold, oil, or cryptocurrency, the relative value of the medium must be accepted by all parties and must be portable enough to allow easy and secure access. Storage and shipping of goods are still essential to the success of a vendor or the satisfaction of the consumer. And despite all of our digital sophistication, human interaction is still required at many levels of ecommerce. From video meetings to livestream events, phone conference calls to texting, in the end, the human touch remains the best way to exchange goods and services between businesses, governments, and individuals.

### SUMMARY

Short-form videos and livestream events have become important means of communication in ecommerce marketing and sales. As more goods and services are offered through digital storefronts and networks, finding the best spokesperson to represent products to potential buyers has become a critical component to successful marketing. Short-form videos and livestreams have become more sophisticated, and the audiences are becoming increasingly selective in their choices of message content, means of delivery, and deliverers of messages. Ecommerce consumers can be influenced to purchase products or services based on recommendations from trusted sources (like influencers) on various social networks. This influence can take place via posts from influencers and tastemakers, as well as friends and other connections within the social media systems. In many cases, influencers are paid for their efforts by website owners or advertising groups. Celebrities and product experts also gather followers on social media platforms and can influence which products are purchased and how they are used. Sales representatives for various brands or vendors can also develop groups of buyers who are influenced to purchase products based on their demonstrations and recommendations. Just as a consumer might seek out a particular salesperson in a favorite department store, ecommerce consumers can log into social media outlets and internet platforms to purchase products from their chosen livestream host. Rather than logging into a large consumer shopping website with multiple departments, smaller, tailored mini websites can be used to represent particular sections of a broader inventory, hosted by salespeople or media influencers with a stronger appeal to the viewer.

Disclosed embodiments provide techniques for scaling ecommerce with a short-form video. A micro-website is created and associated with a user ID. The user ID corresponds to a social media influencer, an expert in a subject matter, or a celebrity. The micro-website can be managed by a mobile application. Based on the user ID, a pre-approved electronic catalog of products is determined and used to populate the micro-website with one or more products for sale. The micro-website includes one or more short-form videos highlighting products for sale from the electronic catalog. The host of the short-form videos is the influencer, expert, or celebrity corresponding to the user ID. The micro-website includes an ecommerce link to allow the fulfillment of product orders. The short-form videos include a virtual purchase cart for ecommerce purchases that can be engaged by the user.

A computer-implemented method for video editing is disclosed comprising: creating a micro-website, wherein the micro-website is associated with a user ID; determining a pre-approved electronic catalog of products from a master catalog, wherein the determining is based on the user ID; populating a back end of the micro-website with one or more products for sale from the pre-approved electronic catalog of products, wherein the populating includes an ecommerce linkage; augmenting a short-form video within the micro-website, wherein the augmenting includes highlighting the one or more products for sale; rendering, in response to a user, the short-form video that was augmented, wherein the rendering includes an ecommerce environment; and fulfilling an ecommerce order, wherein the fulfilling is accomplished by the ecommerce linkage. In embodiments, the ecommerce linkage includes a price, a shipping price, and a shipping method. In embodiments, the rendering includes a product card. In embodiments, the short-form video comprises a livestream, and the user ID is associated with a host of the livestream. And in embodiments, the user ID corresponds to a social media influencer.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for scaling ecommerce with a short-form video.

FIG. 2 is a flow diagram for enabling a checkout for scaling ecommerce with a short-form video.

FIG. 3 is an infographic for scaling ecommerce with a short-form video.

FIG. 4 is an infographic for managing a micro-website.

FIG. 5 is an infographic for adding products to a micro-website.

FIG. 6 illustrates an ecommerce purchase.

FIG. 7 is a system diagram for scaling ecommerce with a short-form video.

### DETAILED DESCRIPTION

Creating effective shopping websites can take many hours of application development, IT network and server setup, security management, inventory control, writing product descriptions, pricing, payment processing, shipping management, and so on. Marketing and advertising efforts for shopping sites can require multiple rounds of print and video development. Shopping websites for large businesses can include hundreds or thousands of products, making categorizing and indexing the product catalogs vitally important so that customers can find the items they wish to buy. Just as in a physical department store or warehouse shopping site, locating a particular product, or getting help on a large ecommerce site can be a challenge. Separating a large catalog of products by departments or subject matter can be helpful. Linking the departments and product categories to website presenters, subject matter experts, and livestream hosts can be even more helpful and effective in driving sales. Selecting the right narrator or host to be the spokesperson can be a critical component in the success of livestream short-form videos, particularly in product promotions. Getting the right presenter can lead to increased market share and revenue.

Short-form livestream videos with an engaging host highlighting and demonstrating products can be an effective way of engaging customers and promoting sales. These videos can be recorded and played back as stand-alone advertisements or demonstrations of products and services and can form the basis for livestream events. Customized micro-websites can be used to play livestream videos featuring hosts with followers from social media, subject experts, sales specialists, and celebrities. A management application for the micro-website can be run from a mobile device, allowing the host to make changes to the list of products available and create livestream videos as they attend sports events, fashion shows, product demonstrations, and so on. Using a micro-website connected to a selected catalog of products and hosted by a chosen sales representative, celebrity, product expert, or social media influencer can allow viewers to be more engaged and more likely to make a purchase. User engagement, numbers of sales, numbers of livestream views, and so on can be more easily measured from a micro-website, allowing for more analysis and expansion of product catalogs as the sites and the site hosts become more effective.

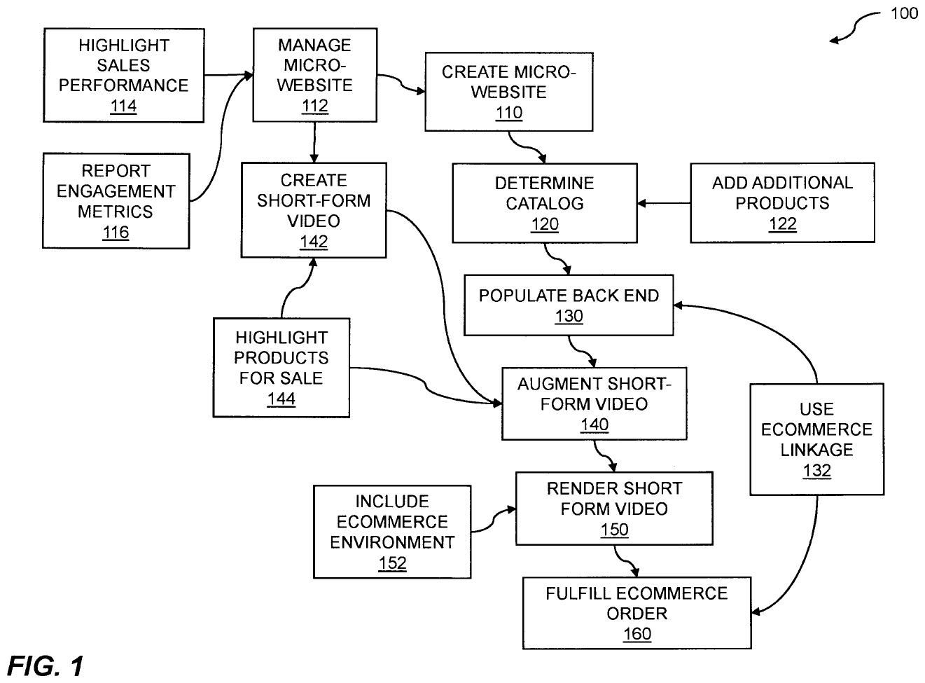

FIG. 1 is a flow diagram 100 for scaling ecommerce with a short-form video. The flow 100 includes creating a micro-website 110, wherein the micro-website is associated with a user ID. In embodiments, the user ID can correspond to a social media influencer, a subject matter expert, a sales representative, or a celebrity. A micro-website is a small website created for a specific purpose, such as a focused sales campaign, an event, or the marketing of products from a specific company. In embodiments, the micro-website is used to collect a group of products from a larger master catalog that can be offered for sale by a specific user. The user ID can represent a sales representative, a subject matter expert, a social media influencer, or a celebrity. The micro-website can be hosted on an independent network domain or can function as a subdomain of the larger company's web network. It can have a different URL than the host company's main website. The advantage to a micro-website is the ability to track sales, the number of views, and so on that are specific to the user ID that acts as host for the website. In embodiments, the number of followers is also tracked. A large company with multiple departments or product offerings, such as a sports department store, could create multiple micro-websites, each dedicated to a particular sport or product department, with each hosted by a separate sales representative, social media influencer, sports personality, or product expert. For example, a local golf pro could host a micro-website selling golf equipment and clothing.

Another micro-website could feature exercise equipment, hosted by a sales representative, for the department store specializing in the equipment being sold. The ability to use website hosts that engage users can increase the opportunity for sales and market share. Successful micro-websites can be analyzed, and the results can be used to increase engagement in other websites representing the company's products for sale.

In the flow 100, the micro-website can be managed by a mobile application 112. The micro-website managing can include highlighting a sales performance 114. The micro-website managing can include reporting one or more engagement metrics 116. The engagement metrics can include a sales goal, a number of views of a short-form video, or a number of followers. Measuring the effectiveness of a micro-website can allow the host company to tailor the website to increase sales and user engagement. In embodiments, the micro-website managing includes creating a short-form video, wherein the one or more products from the pre-approved list of products are highlighted in the short-form video. The short-from video can comprise a livestream. A livestream is a streaming media event that is simultaneously recorded and broadcast in real time over the Internet. It can include audio, video, or both at the same time. Livestreaming can include a wide variety of topics, including sporting events, video games, artistic performances, marketing campaigns, political speeches, advertising presentations, and so on. Once recorded, the livestream event can be replayed and expanded upon as viewers comment and interact with the replay of the livestream event in real time. In embodiments, once the short-form livestream video is created, the list of products offered for sale can be updated to accommodate user requests. Changes can be made to a short-form video livestream to demonstrate different products based on user interests, and so on. The micro-website managing can include achieving one or more engagement metrics, including a sales goal, a number of views, and a number of followers. More successful micro-websites can be expanded to offer more products for sale, the short-form video livestreams can be updated and expanded, and so on. Managing the micro-website from a mobile phone, laptop, or tablet allows the user ID host to create short-form video livestreams while attending related events, walking through a store department, or demonstrating a product. The user ID host can be a sales representative, social media influencer, product or subject expert, or a celebrity. Adjustments to the product offerings, pricing, listing order, and so on can be made dynamically as sales performance and engagement statistics are collected and analyzed.

The flow 100 includes determining a pre-approved electronic catalog of products 120 from a master catalog, wherein the determining is based on the user ID. In embodiments, the master catalog can comprise products sold by a brand. The determining can comprise adding, to the pre-approved catalog of products, additional products 122 from the master catalog. In some embodiments, the determining of products 120 can be based on a social media influencer, the skill of a social media influencer, an experience of a social media influencer, the number of followers of a social media influencer, one or more products associated with a subject matter expert, or on metadata. The list of products to be sold on a micro-website can be selected based on brand, subject matter, experiences, seasons, interests, and so on. The user ID host background, skill set, interests, and follower base can be used as the basis for selecting products to be offered for sale on the website. For example, a social media influencer acting as a micro-website host can offer a catalog of products related to a recent visit to a foreign country or a recent sporting event. A celebrity can display and wear clothing for sale that is related to a particular brand or featured in a movie or TV series, a chef can host a website offering kitchenware, appliances, cookbooks, etc.

The flow 100 includes populating a back end of the micro-website 130 with one or more products for sale from the pre-approved electronic catalog of products 120, wherein the populating includes an ecommerce linkage 132. In embodiments, the ecommerce linkage includes a price, a shipping price, and a shipping method. The micro-website can be linked to the host company's main website, allowing an established ecommerce platform to manage product sales, information, shipping, and so on. Website viewer requests for product information can be forwarded by the primary website, and ecommerce sales can be passed on to the main company site for processing and fulfillment. This allows the micro-website to dedicate its resources to sales and marketing, driven by the user ID host livestream engagement with viewers. The catalog of products for sale is a subset of those offered by the primary host company, as is the ecommerce infrastructure, so that the technical resources required to process sales and deliver the products need not be recreated for each micro-website.

The flow 100 includes augmenting a short-form video 140 within the micro-website, wherein the augmenting includes highlighting the one or more products for sale 144. In embodiments, the short-form video 140 comprises a livestream, wherein the user ID is associated with a host of the livestream. After the micro-website is created, a catalog of products is made available, an ecommerce environment is linked, and a user ID host is assigned, the short-form video can be augmented and tailored to the user ID host. A social influencer or celebrity may present and highlight the products for sale differently than a department sales representative or product expert. A chef or sports pro may use demonstrations to highlight products for sale, rather than merely giving descriptions of products on a countertop or table. The effectiveness of the user ID and their livestream presentations can be measured by the mobile managing application 112. Sales targets, numbers of followers, numbers of views, and so on can be used to assess the effectiveness of micro-websites and their hosts. Adjustments can be made in order to improve performance, and additional products can be added to expand successful livestream engagements.

The flow 100 includes rendering, in response to a user, the short-form video 150 that was augmented, wherein the rendering includes an ecommerce environment 152. In embodiments, the rendering includes a product card. The product card represents at least one product available for purchase while the livestream short-form video plays. Embodiments can include inserting a representation of the first product for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card can be inserted when the livestream is visible in the livestream event. When the product card is invoked, an in-frame shopping environment is rendered over a portion of the video while the video continues to play. This rendering enables an ecommerce purchase by a user while preserving a continuous video playback session. In other words, the user is not redirected to another site or portal that causes the video playback to stop. Thus, viewers are able to initiate and complete a purchase completely inside of the video playback user interface, without being directed away from the currently playing video. Allowing the livestream event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The flow 100 includes fulfilling an ecommerce order 160, wherein the fulfilling is accomplished by the ecommerce linkage 132. In embodiments, the ecommerce environment 152 includes selecting, by the user, the one or more products for sale, and displaying a product details page in response to a user action, such as clicking on a product card. The fulfilling enables an ecommerce purchase, within the ecommerce environment, of the one or more products that were selected by the user. In embodiments, enabling an ecommerce purchase includes a virtual purchase cart, wherein the virtual purchase cart covers a portion of the short-form video. The enabling includes an ability for the user to clip coupons; choose from multiple related products; and update quantity, price, size, color, or other variable aspects of a product. The enabling further comprises completing checkout from the virtual purchase cart.

In embodiments, the livestream host can highlight products and services for sale during the livestream event. The host can demonstrate, endorse, recommend, and otherwise interact with one or more products for sale. An ecommerce purchase of at least one product for sale can be enabled to the user, wherein the ecommerce purchase is accomplished within the livestream window. As the host interacts with and presents the products for sale, a product card can be included within a livestream shopping window. An ecommerce environment associated with the livestream event can be generated on the viewer's mobile device or other connected television device as the event progresses. The ecommerce environment on the viewer's mobile device can display the livestream event and the ecommerce environment at the same time. The mobile device user can interact with the product card in order to learn more about the product with which the product card is associated. While the user is interacting with the product card, the livestream event continues to play. Purchase details of the at least one product for sale are revealed, wherein the revealing is rendered to the viewer. The viewer can purchase the product through the ecommerce environment, including a virtual purchase cart. The viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

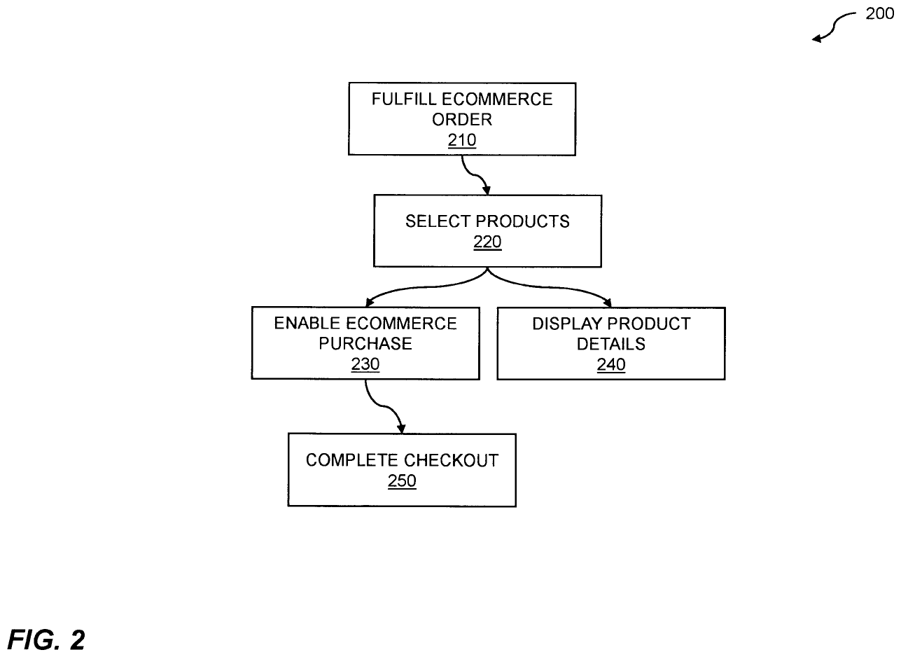

FIG. 2 is a flow diagram 200 for enabling a checkout for scaling ecommerce with a short-form video. As described above and throughout, a micro-website can be created and associated with a user ID that can be a sales representative, social media influencer, a product or subject expert, or a celebrity. A pre-approved electronic catalog of products for sale can be selected from a master catalog of products from a host company website. The micro-website can be linked to an ecommerce environment provided by a primary host website. The ecommerce environment can provide infrastructure, applications, and processes that allow a micro-website user to select and purchase products for sale on the website. The micro-website allows the host user ID to create and augment short-form livestream videos and render them to viewers of the website. The livestream videos can highlight the products for sale selected in the pre-approved catalog of products. The livestream videos can include comments, testimonials, and demonstrations of the products by the user ID host. The micro-website includes the ecommerce environment as part of the livestream video, so that a user can purchase products for sale as the livestream video is playing.

The flow 200 includes fulfilling an ecommerce order 210, wherein the fulfilling is accomplished by the ecommerce linkage. In embodiments, the ecommerce linkage includes a price, a shipping price, and a shipping method. The ecommerce environment can be provided by a primary ecommerce website that acts as a host for a micro-website which is associated with a user ID. The micro-website user ID can be associated with a sales representative for the primary ecommerce company, a social media influencer, a product or subject matter expert, or a celebrity. The micro-website can be linked to a pre-approved catalog of products selected from a master catalog maintained by the primary ecommerce company. The pre-approved catalog of products represents a subset of products that can be highlighted, demonstrated, and sold to users by the host user ID representative. The ecommerce environment allows the primary ecommerce company host website to provide all the detailed product information, such as colors, sizes, quantities, and so on; pricing; shipping methods and pricing; and payment processing infrastructure required to fulfill an ecommerce order generated by a user of the micro-website. This allows the micro-website resources to be dedicated to the presentation, highlighting, and sale of items contained in the pre-approved catalog of products by the host user ID through the creation and augmenting of short-form livestream videos.

The flow 200 includes selecting 220, by the user, the one or more products for sale. As short-form livestream videos are created and augmented by the host user, they are rendered to the micro-website for viewing by customer users. The livestream videos are used to highlight, demonstrate, endorse, recommend, and interact with users as the host presents products from the pre-approved catalog of products linked to the micro-website. The social media influencer, celebrity, product expert, or sales representative can highlight products in the livestream video at the same time that the ecommerce environment is rendered to the micro-website. In embodiments, the product selection is accomplished within the livestream window. As the host interacts with and presents the products for sale, a product card can be included within a livestream shopping window. An ecommerce environment associated with the livestream event can be generated on the viewer's mobile device or other connected television device as the event progresses. The ecommerce environment on the viewer's mobile device can display the livestream event and the ecommerce environment at the same time. The mobile device user can interact with the product card in order to learn more about the product with which the product card is associated. While the user is interacting with the product card, the livestream event continues to play. Purchase details of the at least one product for sale are revealed, wherein the revealing is rendered to the viewer. The viewer can purchase the product through the ecommerce environment, which includes a virtual purchase cart. The viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event. In some embodiments, the synthesized video segment can display the virtual product cart while the synthesized video segment plays. The virtual product cart can cover a portion of the synthesized video segment while it plays.

The flow 200 includes enabling an ecommerce purchase 230, within the ecommerce environment, of the one or more products that were selected. In embodiments, enabling the ecommerce environment purchase includes a product card, and a virtual purchase cart when a purchase is selected by the user. The virtual product cart covers a portion of the short-form livestream video as it plays. The enabling includes an ability for the user to clip coupons, and update quantity, price, size, color, or other variable aspects of a product. The user can also choose from multiple related products to purchase. The virtual purchase cart can appear as an icon, a pictogram, a representation of a purchase cart, and so on. The virtual purchase cart can appear as a cart, a basket, a bag, a tote, a sack, and the like. Using a mobile phone or other connected television (CTV) device, such as a smart TV; a television connected to the internet via a cable box, TV stick, or game console; a pad; a tablet; a laptop; or a desktop computer, etc., the viewer can click on the product or on the virtual purchase cart to add the product to the purchase cart. The viewer can click again on the virtual purchase cart to open the cart and display the cart contents. The viewer can save the cart, edit the contents of the cart, delete items in the cart, etc. In some embodiments, the virtual purchase cart rendered to the viewer can cover a portion of the livestream window. The portion of the livestream window can range from a small portion to substantially all of the livestream window. In some embodiments, the synthesized video segment can display the virtual product cart while the synthesized video segment plays. The virtual product cart can cover a portion of the synthesized video segment while it plays. However much of the livestream window is covered by the virtual purchase cart, the livestream event continues to play while the viewer is interacting with the virtual purchase cart.

The flow 200 includes displaying a product details page 240 in response to a user action. In embodiments, a representation of a product being highlighted by a host user on the micro-website can be rendered to the livestream video window as the video plays. The product representation can include an image or video of the product, on-screen text and/or images, spoken words or other verbal utterances, metadata embedded within the user data of a video stream, etc. A product card can be created and displayed on the micro-website based on the product representation. Product details can be selected through a user action. The user selection can include a swipe, press, mouse click, gesture, verbal utterance, or other suitable user action. Upon selection, additional information about the product can be displayed, and the flow includes adding the product displayed to a virtual purchase cart. The virtual purchase cart can hold one or more items. The virtual purchase cart can include a virtual shopping cart, a virtual shopping bag, a virtual tote, etc. In embodiments, adding a product includes enabling a display interaction with a representation for the product. The product can be represented by an icon or other image.

The flow 200 can include displaying coupons. The coupons can include a quick response (QR) code, barcode, alphanumeric code, or other suitable indicia. In this way, product demonstrations and/or promotions within livestreams, livestream replays, and/or other short-form videos are enhanced. The flow includes updating variable aspects of the product. In embodiments, the adding includes the ability for the user to update quantity, price, size, color, or other variable aspects of a product. Some embodiments also include shipping options, so that users can select an appropriate shipping method for the item based on their needs and budget. The flow can include collecting customer information. The customer information can include a phone number and/or email address; and payment details can include customer name, shipping address, credit card details and associated payment card address (if different from shipping address). In some embodiments, the payment details include digital wallet information for support of purchases through cryptocurrencies such as Bitcoin and the like.

The flow 200 includes completing checkout 250 from the virtual purchase cart. In embodiments, the checkout can include charging the customer via the specified payment method (credit card, gift card, cryptocurrency, etc.), and/or processing the order for the product. The completing can also include finalizing a purchase of the product upon conclusion of the short-form video. The flow can also include using a batch order process. In embodiments, when multiple items are purchased via product cards during the playback of a short-form video, the purchases are cached until termination of the video. The termination of the livestream video can include the user stopping playback, the user exiting the video window, the livestream ending, or a prerecorded video ending. The batch order process can enable a more efficient use of computer resources, such as network bandwidth, by processing the orders together as a batch. Prior to termination of the short-form video, the user can cancel orders that were placed during the playing of the short-form video, which can include clearing/emptying a virtual purchase cart. Thus, embodiments include cancelling a purchase decision for the product within a duration for the short-form video.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

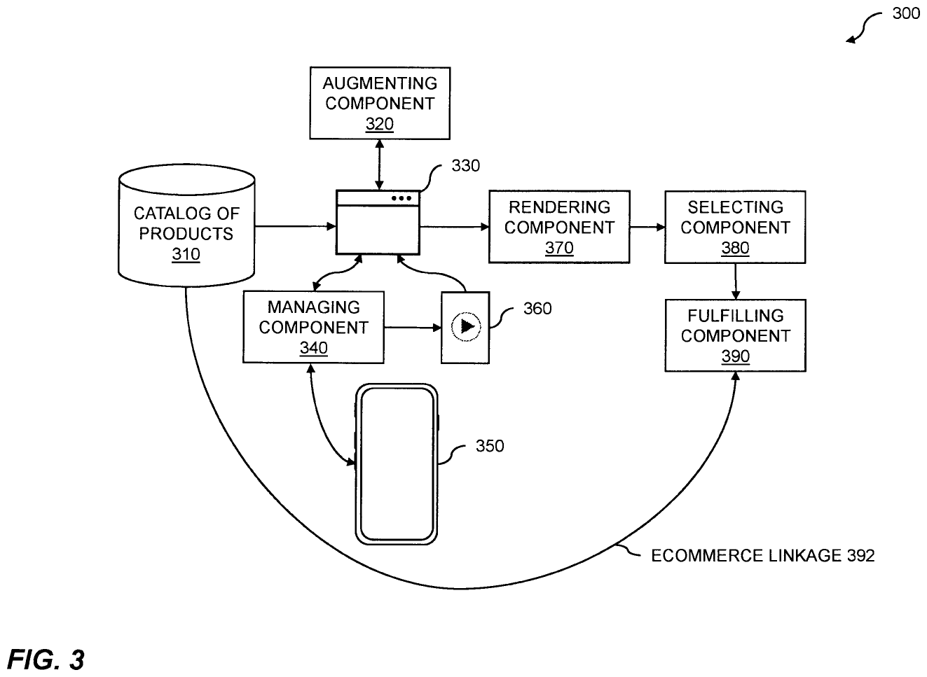

FIG. 3 is an infographic for scaling ecommerce with a short-form video. The infographic 300 includes creating a micro-website 330, wherein the micro-website is associated with a user ID. In embodiments, the user ID is linked to a sales representative, social media influencer, subject matter or product expert, or a celebrity. The selection of the user ID can be based on metadata related to the user ID, including name, address, email address, phone number, employer, gender, picture, location, languages spoken, popularity, etc. The user ID selection can also be based on skills, number of followers, products or subjects associated with the user, and so on. The user ID acts as the host of short-form livestreams rendered on the micro-website 330. The livestreams are created and augmented to promote products for sale, thus the host user ID is selected to engage viewers and encourage sales.

The infographic 300 includes a pre-approved electronic catalog of products 310 from a master catalog, wherein the selection is based on the host user ID. In embodiments, the catalog of products 310 can be selected based on subject or product expertise, skills related to one or more products, number of followers, experiences of the host user related to particular products, etc. For example, a professional baseball player could host a micro-website selling baseball equipment, shoes, hats, and so on. Another micro-website could feature makeup, hosted by a celebrity or social media influencer with followers interested in beauty and personal care products. The ability to use website hosts that engage users can increase the opportunity for sales and market share.

The infographic 300 includes populating a back end of the micro-website 330 with one or more products for sale from the pre-approved electronic catalog of products 310, wherein the populating includes an ecommerce linkage 392. In embodiments, the ecommerce linkage includes a price, a shipping price, and a shipping method. The micro-website can be linked to the host company's main website, allowing an established ecommerce platform to manage product sales, information, shipping, and so on. Website viewer requests for product information can be forwarded by the primary website, and ecommerce sales can be passed on to the main company site for processing and fulfillment. This allows the micro-website to dedicate its resources to sales and marketing, driven by the user ID host livestream engagement with viewers. The catalog of products for sale is a subset of those offered by the primary host company, as is the ecommerce infrastructure, so that the technical resources required to process sales and deliver the products need not be recreated for each micro-website.

The infographic 300 includes a managing component 340 using a mobile application 350. In embodiments, the managing component includes sales and engagement metrics associated with the micro-website and can be used to set performance goals and measure success rates in achieving the goals. Sales goals, numbers of livestream views, numbers of followers, and so on can be measured and tracked by the managing component and viewed on the mobile application. Reporting related to the engagement and sales metrics can be generated by the mobile application. Measuring the effectiveness of a micro-website can allow the host company to tailor the website to increase sales and user engagement.

In embodiments, the micro-website managing component 340 includes creating a short-form video 360, wherein the one or more products from the catalog of products 310 is highlighted in the short-form video. The short-form video 360 comprises a livestream. The list of products offered for sale can be updated to accommodate user requests, changes can be made to a short-form video livestream to demonstrate different products based on user interests, and so on. Based on the engagement and sales metrics, more successful micro-websites can be expanded to offer more products for sale, the short-form video livestreams can be updated and augmented, and so on. Managing the micro-website from a mobile phone, laptop, or tablet allows the host user ID to create short-form video livestreams while attending related events, walking through a store department, or demonstrating a product. Adjustments to the product offerings, pricing, listing order, and so on can be made dynamically as sales performance and engagement statistics are collected and analyzed.

The infographic 300 includes an augmenting component 320 for a short-form video generated by the managing component 340, wherein the augmenting includes highlighting the one or more products for sale. In embodiments, the short-form video created by the managing component comprises a livestream, wherein the user ID is associated with a host of the livestream. After the micro-website 330 is created, a catalog of products 310 is made available, an ecommerce environment is linked 392, and a user ID host is associated, the short-form video 360 can be augmented 320 and tailored to the user ID host. A social influencer or celebrity may present and highlight the products for sale differently than would a department sales representative or product expert. A chef or sports pro may use demonstrations to highlight products for sale, rather than descriptions of products on a countertop or table. The effectiveness of the user ID and their livestream presentations can be measured by the mobile managing application. Sales targets, numbers of followers, numbers of views, and so on can be used to assess the effectiveness of micro-websites and their hosts. Adjustments can be made in order to improve performance, and additional products can be added to expand successful livestream engagements.

The infographic 300 includes a rendering component 370. In embodiments, the rendering component publishes the augmented short-form livestream video to the micro-website, including an ecommerce environment within the livestream window, to allow purchasing of products highlighted by the host user ID in the livestream video. The rendering of the ecommerce environment includes a product card. The product card represents at least one product available for purchase while the livestream short-form video plays. Embodiments can include inserting a representation of a highlighted product for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card can be inserted when the livestream is visible in the livestream event. When the product card is invoked, an in-frame shopping environment is rendered over a portion of the video while the video continues to play. This rendering enables an ecommerce purchase by a user while preserving a continuous video playback session. In other words, the user is not redirected to another site or portal that causes the video playback to stop. Thus, viewers are able to initiate and complete a purchase completely inside of the video playback user interface, without being directed away from the currently playing video. Allowing the livestream event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The infographic 300 includes a selecting component 380. In embodiments, the ecommerce environment rendered on the micro-website 330 includes selecting, by the user, the one or more products for sale, and displaying a product details page in response to a user action, such as clicking on a product card. The selecting enables an ecommerce purchase, within the ecommerce environment, of the one or more products that were selected by the user. In embodiments, enabling an ecommerce purchase includes a virtual purchase cart, wherein the virtual purchase cart covers a portion of the short-form video. The enabling includes an ability for the user to clip coupons; choose from multiple related products; and update quantity, price, size, color, or other variable aspects of a product. The enabling further comprises completing checkout from the virtual purchase cart.

The infographic 300 includes a fulfilling component 390. In embodiments, the livestream host can highlight products and services for sale during the livestream event rendered on the micro-website 330. The host can demonstrate, endorse, recommend, and otherwise interact with one or more products for sale. An ecommerce purchase of at least one product for sale can be enabled to the user, wherein the ecommerce purchase is accomplished within the livestream window. As the host interacts with and presents the products for sale, a product card can be included within a livestream shopping window. An ecommerce environment associated with the livestream event can be generated on the viewer's mobile device or other connected television device as the event progresses. The ecommerce environment on the viewer's mobile device can display the livestream event and the ecommerce environment at the same time. The mobile device user can interact with the product card in order to learn more about the product with which the product card is associated. While the user is interacting with the product card, the livestream event continues to play. Purchase details of the at least one product for sale are revealed, wherein the revealing is rendered to the viewer. The viewer can purchase the product through the ecommerce environment, including a virtual purchase cart. The viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event.

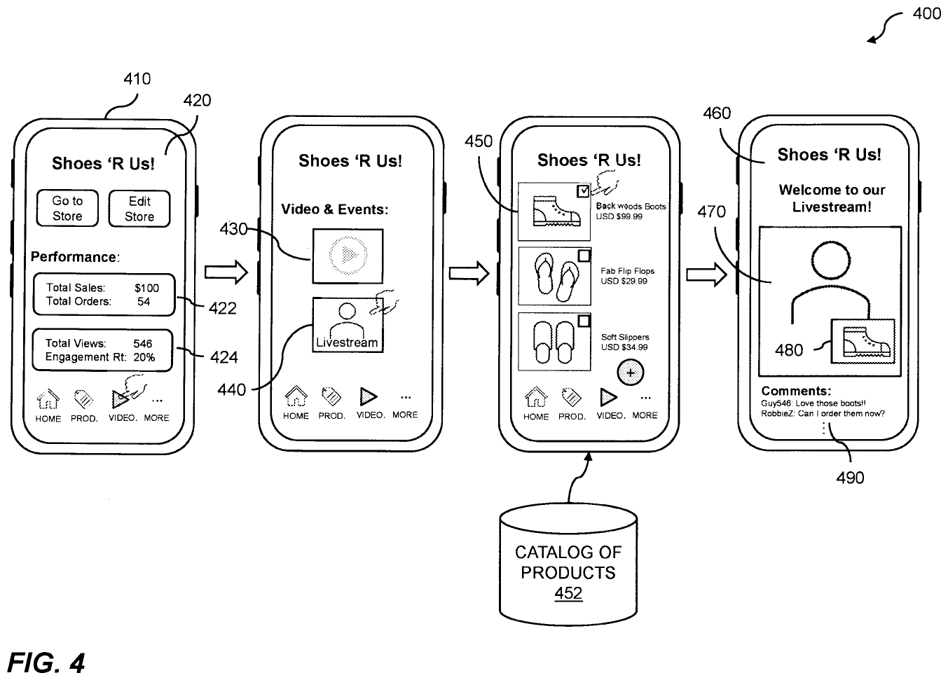

FIG. 4 is an infographic for managing a micro-website using a mobile application. A micro-website is a small website created for a specific purpose, such as a focused sales campaign, or to promote an event or products from a specific company. In embodiments, the micro-website is used to collect a group of products from a larger master catalog that can be offered for sale by a specific user. The micro-website can be hosted on an independent network domain or function as a subdomain of the larger company's web network. It can have a different URL than the host company's main website. The infographic 400 includes a mobile device 410 that can run a mobile application 420 for managing the micro-website. In embodiments, the management application can be run by internet connected devices such as a laptop computer, desktop computer, pad, tablet, or mobile phone. The management application can display technical and performance details related to the micro-website and render the micro-website as other users experience it.

The infographic 400 includes sales and performance information related to the micro-website. The micro-website managing application 420 includes reporting one or more sales metrics 422 that can include sales goals, total sales, and dollars in sales 422, as well as website engagement metrics 424 such as number of views of a short-form video, number of followers, percentage of views leading to actual sales, etc. Measuring the effectiveness of a micro-website can allow the host company to tailor the website to increase sales and user engagement. In embodiments, the micro-website managing application includes creating a short-form video, wherein the one or more products from the pre-approved catalog of products is highlighted in the short-form video. The short-from video can comprise a livestream 440 or can be recorded and stored 430 for use at a later time. The catalog of products 452 offered for sale can be updated 450 by the host user ID to accommodate user requests. Further, changes can be made to a short-form video livestream 440 to demonstrate different products based on user interests, and so on. Successful micro-websites can be expanded to offer more products for sale, the short-form video livestreams can be updated and expanded, and so on. Managing the micro-website from a mobile phone 410, laptop, or tablet allows the user ID host to create short-form video livestreams 440 while attending related events, walking through a store department, or demonstrating a product. Adjustments to the product offerings, pricing, listing order, and so on can be made dynamically as sales performance and engagement statistics are collected and analyzed.

The infographic 400 includes rendering an ecommerce environment that enables highlighted products from the catalog of products 452 to be purchased. In embodiments, the ecommerce environment includes product prices, shipping prices, and shipping methods. The micro-website can be linked to the host company's main website, allowing an established ecommerce platform to manage product sales, information, shipping, and so on. The catalog of products for sale is a subset of those offered by the primary host company, as is the ecommerce infrastructure, so that the technical resources required to process sales and deliver the products need not be recreated for each micro-website. Website viewer requests for product information can be forwarded by the primary website, and ecommerce sales can be passed on to the main company site for processing and fulfillment. The ecommerce environment allows the primary ecommerce company host website to provide all the detailed product information, such as color, size, quantity, and so on; pricing; shipping methods and pricing; and payment processing infrastructure required to fulfill an ecommerce order generated by a user of the micro-website. This allows the micro-website resources to be dedicated to the presentation, highlighting, and sale of items contained in the pre-approved catalog of products by the host user ID through the creation and augmenting of short-form livestream videos.

The infographic 400 includes rendering a livestream 470 on the micro-website window 460 while displaying product cards as part of the ecommerce environment as the livestream progresses. As short-form livestream videos are created and augmented by the host user, they are rendered to the micro-website for viewing by customer users. The livestream videos are used to highlight, demonstrate, endorse, recommend, and interact with users as the host presents products from the pre-approved catalog of products linked to the micro-website. The user host social media influencer, celebrity, product expert, or sales representative can highlight products in the livestream video 470 at the same time that the ecommerce environment is rendered to the micro-website. In embodiments, the product selection is accomplished within the livestream window. As the host interacts with and presents the products for sale, a product card 480 can be included within a livestream shopping window. An ecommerce environment associated with the livestream event can be generated on the viewer's mobile device or other connected television device as the event progresses. The ecommerce environment on the viewer's mobile device can display the livestream event 470 and the ecommerce environment product card 480 at the same time. The ecommerce environment can further include a chat window 490. The chat window can include comments and questions from viewers of the short-form video shown in the livestream window 460. This can enable additional engagement with the ecommerce short-form livestream video and the host user. The mobile device user can interact with the host user, other users, and the product card in order to learn more about the product with which the product card is associated. While the user is interacting with the product card and the chat window, the livestream event continues to play. Purchase details of the at least one product for sale can be revealed, wherein the revealing is rendered to the viewer. The viewer can purchase the product through the ecommerce environment, including a virtual purchase cart. The viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event. In some embodiments, the synthesized video segment can display the virtual product cart while the synthesized video segment plays. The virtual product cart can cover a portion of the synthesized video segment while it plays.

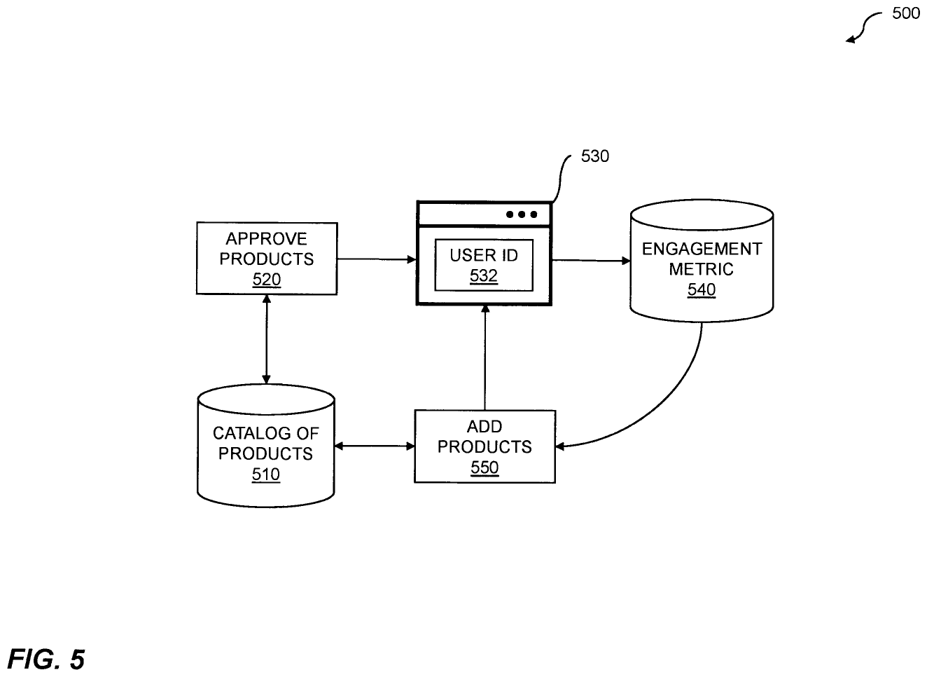

FIG. 5 is an infographic for adding products to a micro-website. The infographic 500 includes a large master catalog 510 of products that can be offered for sale. In embodiments, a micro-website 530 that is associated with a user ID 532 can be created. The micro-website 530 is used to collect and approve a group of products 520 from a larger master catalog 510 that can be offered for sale by a specific host user. The user ID 532 can represent a sales representative, a subject matter expert, a social media influencer, or a celebrity. The advantage to a micro-website 530 is the ability to track sales, the number of followers, the number of views, and so on that are specific to the user ID 532 that acts as host for the website. A large company with multiple departments or product offerings, such as a sports department store, could create multiple micro-websites, each dedicated to a particular sport or product department, with each hosted by a separate sales representative, social media influencer, sports personality, or product expert.

In embodiments, the approved list of products 520 can populate the back end of the micro-website 530 with one or more products for sale, wherein the populating includes an ecommerce linkage. In embodiments, the ecommerce linkage includes a price, a shipping price, and a shipping method, and details about the products such as color, size, quantities, etc. The micro-website can be linked to the host company's main website, allowing an established ecommerce platform to manage product sales, information, shipping, and so on. Website viewer requests for product information can be forwarded by the primary website, and ecommerce sales can be passed on to the main company site for processing and fulfillment. This allows the micro-website to dedicate its resources to sales and marketing, driven by the host user ID 532 livestream engagement with viewers. The approved products for sale 520 are a subset of those offered by the primary host company catalog of products 510, as is the ecommerce infrastructure, so that the technical resources required to process sales and deliver the products need not be recreated for each micro-website.

The micro-website 530 can be managed by a mobile application, wherein the micro-website management includes highlighting sales performance. The micro-website managing application includes reporting one or more engagement metrics 540, wherein the engagement metrics can include a sales goal, a number of views of a short-form video, or a number of followers. Measuring the effectiveness of a micro-website can allow the host company to tailor the website to increase sales and user engagement. In embodiments, the micro-website management includes creating a short-form video, wherein the one or more products from the pre-approved list of products 520 is highlighted in the short-form video. The short-from video comprises a livestream. The list of products offered for sale can be updated to accommodate user requests. Additionally, changes can be made to a short-form video livestream to demonstrate different products based on user interests, and so on. The micro-website managing can include achieving one or more engagement metrics 540, including a sales goal, number of views, and a number of followers. More successful micro-websites can be expanded to offer more products for sale, the short-form video livestreams can be updated and expanded, and so on. Managing the micro-website from a mobile phone, laptop, or tablet allows the user ID host to create short-form video livestreams while attending related events, walking through a store department, or demonstrating a product. Adjustments to the product offerings, pricing, listing order, and so on can be made dynamically as sales performance and engagement statistics are collected and analyzed.

The infographic 500 includes adding products 550 to the pre-approved electronic catalog of products 520 from the master catalog 510. In embodiments, the selection of products can be based on a social media influencer, the skill of a social media influencer, an experience of a social media influencer, the number of followers of a social media influencer, one or more products associated with a subject matter expert, or on metadata. The list of products to be sold on a micro-website can be selected based on brand, subject matter, experiences, seasons, interests, and so on. The host user ID's 532 background, skill set, interests, and follower base can be used as the basis for selecting products to be offered for sale on the website. For example, a social media influencer acting as a micro-website host can offer a catalog of products related to a recent visit to a foreign country or a recent sporting event. A celebrity can display and wear clothing for sale that is related to a particular brand or featured in a movie or TV series. A chef can host a website offering kitchenware, appliances, cookbooks, etc. The engagement metrics 540, including a sales goal, a number of views, and a number of followers, can be analyzed as short-form livestream videos are created, augmented, and rendered to the micro-website 530 for viewing by users. Successful micro-websites can add products 550 to offer more items for sale, the short-form video livestreams can be updated and expanded, and so on. Managing the micro-website from a mobile phone, laptop, or tablet allows the user ID host to add products 550 from the main catalog of products 510 and create more short-form video livestreams. The short-from videos can be created by the host user ID 532 while attending related events, walking through a store department, or demonstrating a product. Adjustments to the product offerings, pricing, listing order, and so on can be made dynamically as sales performance and engagement statistics are collected and analyzed. For example, a sports sales representative could attend a local golf tournament and create a short-form livestream using the micro-website management application on a mobile phone. As the livestream event plays, the host user ID could approve additional golf-related products 520 for sale on the micro-website. Product information from the ecommerce environment rendered on the micro-website would be immediately available from the linkage to the primary host website, as well as the sales processing infrastructure. Additional sales and engagement metrics can be collected and analyzed to assess the effectiveness of the livestream event.

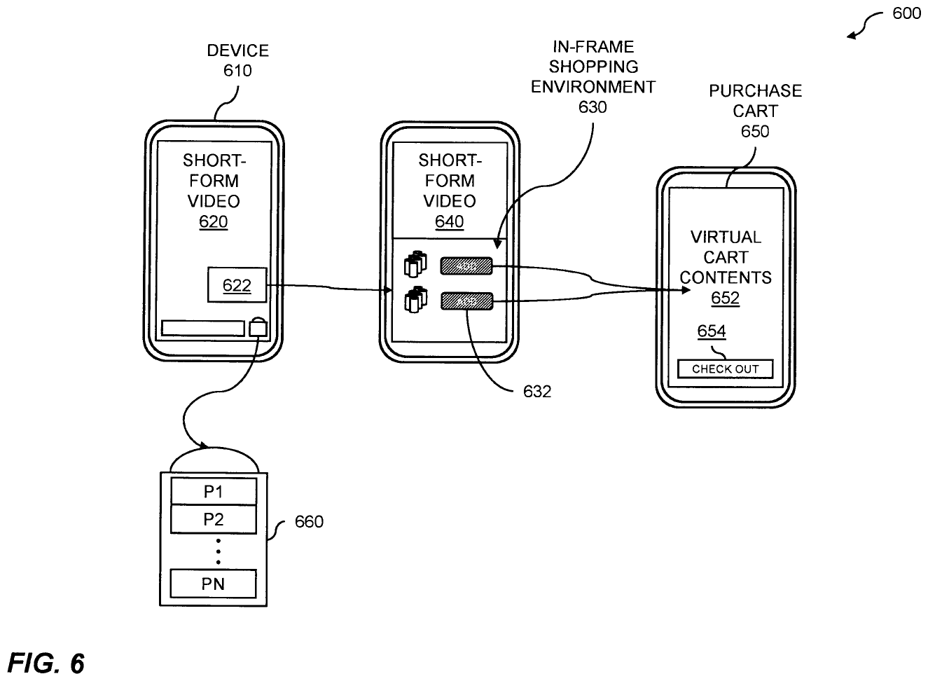

FIG. 6 illustrates an ecommerce purchase. As described above and throughout, a short-form livestream video can be rendered to one or more viewers. The livestream can highlight one or more products available for purchase during the livestream event. An ecommerce purchase can be enabled during the livestream event using an in-frame shopping environment. The in-frame shopping environment can allow internet connected television (CTV) viewers and participants of the livestream event to buy products and services during the livestream event. The livestream event can include an on-screen product card that can be viewed on a CTV device and a mobile device. The in-frame shopping environment or window can also include a virtual purchase cart that can be used by viewers as the short-form video livestream event plays.

The illustration 600 includes a device 610 displaying a short-form video 620 as part of a livestream event. In embodiments, the livestream can be viewed in real time or replayed at a later time. The device 610 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In embodiments, the accessing the livestream on the device can be accomplished using a browser or another application running on the device.

The illustration 600 includes generating and revealing a product card 622 on the device 610. In embodiments, the product card represents at least one product available for purchase while the livestream short-form video plays. Embodiments can include inserting a representation of the first object into the on-screen product card. A product card is a graphical clement such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card 622 can be inserted when the livestream is visible in the livestream event short-form video 640. When the product card is invoked, an in-frame shopping environment 630 is rendered over a portion of the video while the video continues to play. This rendering enables an ecommerce purchase 632 by a user while preserving a continuous video playback session. In other words, the user is not redirected to another site or portal that causes the video playback to stop. Thus, viewers are able to initiate and complete a purchase completely inside of the video playback user interface, without being directed away from the currently playing video. Allowing the livestream event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The illustration 600 includes rendering an in-frame shopping environment 630 enabling a purchase of the at least one product for sale by the viewer, wherein the ecommerce purchase is accomplished within the livestream event short-form video window 640. In embodiments, the livestream event can include the livestream and/or a prerecorded video segment. The enabling can include revealing a virtual purchase cart 650 that supports checkout 654 of virtual cart contents 652, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 660 are purchased via product cards during the livestream event, the purchases are cached until termination of the video, at which point the orders are processed as a batch. The termination of the video can include the user stopping playback, the user exiting the video window, the livestream ending, or a prerecorded video ending. The batch order process can enable a more efficient use of computer resources, such as network bandwidth, by processing the orders together as a batch instead of processing each order individually.

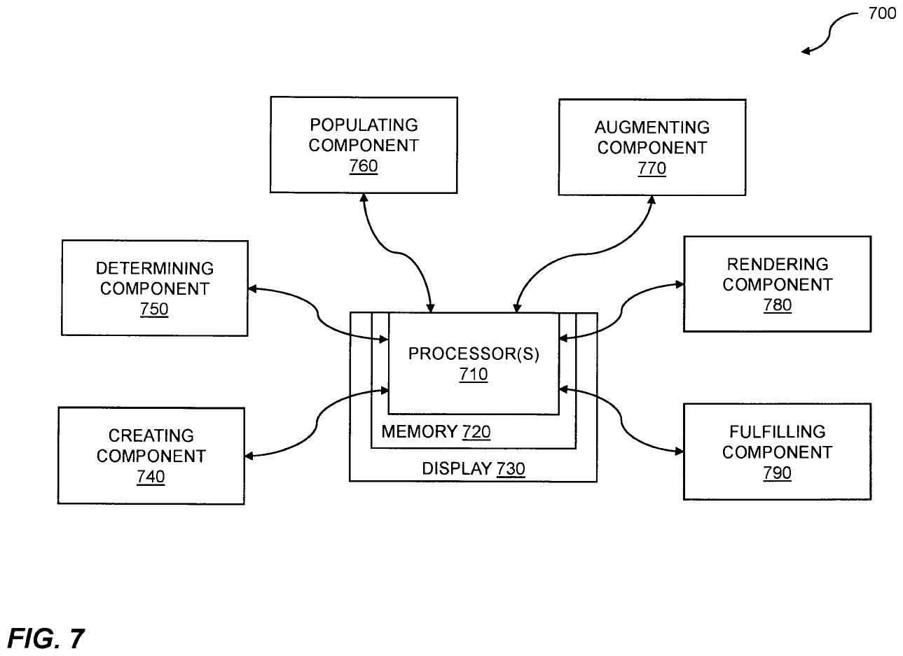

FIG. 7 is a system diagram for scaling ecommerce with a short-form video. The system 700 can include one or more processors 710 coupled to a memory 720 which stores instructions. The system 700 can include a display 730 coupled to the one or more processors 710 for displaying data, video streams, videos, intermediate steps, instructions, and so on. In embodiments, one or more processors 710 are coupled to the memory 720 where the one or more processors, when executing the instructions which are stored, are configured to: create a micro-website, wherein the micro-website is associated with a user ID; determine a pre-approved electronic catalog of products from a master catalog, wherein the determining is based on the user ID; populate a back end of the micro-website with one or more products for sale from the pre-approved electronic catalog of products, wherein the populating includes an ecommerce linkage; augment a short-form video within the micro-website, wherein the augmenting includes highlighting the one or more products for sale; render, in response to a user, the short-form video that was augmented, wherein the rendering includes an ecommerce environment; and fulfill an ecommerce order, wherein the fulfilling is accomplished by the ecommerce linkage.

The system 700 includes a creating component 740. The creating component 740 can include functions and instructions for creating a micro-website, wherein the micro-website is associated with a user ID. In embodiments, the user ID corresponds to a social media influencer, an expert in a subject matter, a celebrity, or a sales representative. The micro-website is a small website created for a specific purpose, such as a focused sales campaign, an event, or products from a specific company. The micro-website can be hosted on an independent network domain or can function as a subdomain of the larger company's web network. It can have a different URL than the host company's main website. The advantage to a micro-website is the ability to track sales, the number of followers, the number of views, and so on that are specific to the user ID that acts as host for the website. A large company with multiple departments or product offerings, such as a sports department store, could create multiple micro-websites, each dedicated to a particular sport or product department, with each hosted by a separate sales representative, social media influencer, sports personality, or product expert. The ability to use website hosts that engage users can increase the opportunity for sales and market share. Successful micro-websites can be analyzed, and the results used to increase engagement in other websites representing the company's products for sale.

The creating component 740 further comprises creating a short-form video, wherein one or more products from a pre-approved list of products is highlighted in the short-form video. In some embodiments, the short-form video comprises a livestream. The user ID is associated with a host of the livestream. A livestream is a streaming media event that is simultaneously recorded and broadcast in real time over the Internet. It can include audio, video, or both at the same time. Livestreaming can include a wide variety of topics, including sporting events, video games, artistic performances, marketing campaigns, political speeches, advertising presentations, and so on. Once recorded, the livestream event can be replayed and expanded upon as viewers comment on and interact with the replay of the livestream event in real time. In embodiments, after the short-form livestream video is created, a list of products offered for sale can be updated to accommodate user requests. Changes can be made to a short-form video livestream to demonstrate different products based on user interests, and so on.

The system 700 includes a determining component 750. The determining component 750 can include functions and instructions for determining a pre-approved electronic catalog of products from a master catalog, wherein the determining is based on the user ID. In some embodiments, the master catalog comprises products sold by a brand. The determining component 750 can base the selection of products on the social media influencer, a skill of the social media influencer, an experience of the social media influencer, the number of followers of the social media influencer, one or more products associated with a subject matter expert, or metadata related to the user ID. The list of products to be sold on a micro-website can be selected based on brand, subject matter, experiences, seasons, interests, and so on. For example, a social media influencer acting as a micro-website host can offer a catalog of products related to a recent visit to a foreign country or a recent sporting event. A celebrity can display and wear clothing for sale that is related to a particular brand or featured in a movie or TV series. A chef can host a website offering kitchenware, appliances, cookbooks, etc.

The determining component 750 further comprises managing the micro-website by a mobile application, wherein the managing includes highlighting a sales performance, including reporting, by the mobile application, one or more sales engagement metrics. The engagement metrics can comprise a sales goal, a number of views of the short-form video, and a number of followers. In embodiments, the managing application includes sales and engagement metrics associated with the micro-website and can be used to set performance goals and measure success rates in achieving the goals. Sales goals, numbers of livestream views, numbers of followers, and so on can be measured and tracked by the determining component 750 and viewed on the mobile application. Reporting related to the engagement and sales metrics can be generated by the mobile application. Measuring the effectiveness of a micro-website can allow the host company to tailor the website to increase sales and user engagement.

The system 700 includes a populating component 760. The populating component 760 can include functions and instructions for populating a back end of the micro-website with one or more products for sale from the pre-approved electronic catalog of products, wherein the populating includes an ecommerce linkage. In embodiments, the ecommerce linkage includes a price, a shipping price, and a shipping method. The micro-website can be linked to the host company's main website, allowing an established ecommerce platform to manage product sales, information, shipping, and so on. Website viewer requests for product information can be forwarded by the primary website, and ecommerce sales can be passed on to the main company site for processing and fulfillment. This allows the micro-website to dedicate its resources to sales and marketing, driven by the user ID host livestream engagement with viewers. The catalog of products for sale is a subset of those offered by the primary host company, as is the ecommerce infrastructure, so that the technical resources required to process sales and deliver the products need not be recreated for each micro-website.

The populating component 760 further comprises adding, to the pre-approved electronic catalog of products, additional products from the master catalog. The adding can be based on the micro-website achieving an engagement metric, wherein the engagement metric comprises a sales goal, a number of views of the short-form video, and a number of followers. Adjustments to the product offerings, pricing, listing order, and so on can be made dynamically as sales performance and engagement statistics are collected and analyzed. For example, a sports sales representative could attend a local golf tournament and create a short-form livestream using the micro-website management application on a mobile phone. As the livestream event plays, the host user ID could approve additional golf-related products for sale on the micro-website. Product information from the ecommerce environment rendered on the micro-website would be immediately available from the linkage to the primary host website, as well as the sales processing infrastructure. Additional sales and engagement metrics can be collected and analyzed to assess the effectiveness of the livestream event.

The system 700 includes an augmenting component 770. The augmenting component 770 can include functions and instructions for augmenting a short-form video within the micro-website, wherein the augmenting includes highlighting the one or more products for sale. In embodiments, the short-form video comprises a livestream, wherein the user ID is associated with a host of the livestream. After the micro-website is created, a catalog of products is made available, an ecommerce environment is linked, and a user ID host is assigned, the short-form video can be augmented and tailored to the user ID host. A social influencer or celebrity may present and highlight the products for sale differently than a department sales representative or product expert. A chef or sports pro may use demonstrations to highlight products for sale, rather than simply providing descriptions of products on a countertop or table. The effectiveness of the user ID and their livestream presentations can be measured by the mobile managing application. Sales targets, numbers of followers, numbers of views, and so on can be used to assess the effectiveness of micro-websites and their hosts. Adjustments can be made in order to improve performance, and additional products can be added to expand successful livestream engagements.

The system 700 includes a rendering component 780. The rendering component 780 can include functions and instructions for rendering, in response to a user, the short-form video that was augmented, wherein the rendering includes an ecommerce environment. In embodiments, the rendering of an ecommerce environment includes a product card. The product card represents at least one product available for purchase while the livestream short-form video plays. Embodiments can include inserting a representation of a product for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card can be rendered when the livestream is visible in the livestream event. When the product card is invoked, an in-frame shopping environment is rendered over a portion of the video while the video continues to play. This rendering enables an ecommerce purchase by a user while preserving a continuous video playback session.

The rendering component 780 further comprises selecting, by the user, one or more products for sale. As short-form livestream videos are created and augmented by the host user, they are rendered to the micro-website for viewing by customer users. The livestream videos are used to highlight, demonstrate, endorse, recommend, and interact with users as the host presents products from the pre-approved catalog of products linked to the micro-website. An ecommerce environment associated with the livestream event can be rendered on the viewer's mobile device or other connected television device as the event progresses. The social media influencer, celebrity, product expert, or sales representative can highlight products in the livestream video at the same time as the ecommerce environment is rendered to the micro-website. The viewer's mobile device can display the livestream event and the ecommerce environment at the same time. As the host interacts with and presents the products for sale, a product card can be included within a livestream shopping window. The ecommerce environment can further include a chat window. The chat window can include comments and questions from viewers of the short-form video shown in the livestream window. This can enable additional engagement with the ecommerce short-form livestream video and the host user. The mobile device user can interact with the host user, other users, and the product card in order to learn more about the product with which the product card is associated. While the user is interacting with the chat window, the livestream event continues to play. The mobile device user can interact with the product card in order to learn more about the product with which the product card is associated. While the user is interacting with the product card, the livestream event continues to play. Purchase details of the at least one product for sale are revealed, wherein the revealing is rendered to the viewer. The viewer can purchase the product through the ecommerce environment, including a virtual purchase cart.

The system 700 includes a fulfilling component 790. The fulfilling component 790 can include functions and instructions for fulfilling an ecommerce order wherein the fulfilling is accomplished by the ecommerce linkage. In embodiments, the enabling of an ecommerce purchase within the ecommerce environment includes a virtual purchase cart. The virtual purchase cart covers a portion of the short-form livestream video as the video plays. The enabling includes an ability for the user to clip coupons; to choose from multiple related products; and to update quantity, price, size, color, or other variable aspects of a product for sale. The ecommerce environment allows the primary ecommerce company host website to provide all the detailed product information, such as color, size, quantity, and so on; pricing; shipping methods and pricing; and payment processing infrastructure required to fulfill an ecommerce order generated by a user of the micro-website. This allows the micro-website resources to be dedicated to the presentation, highlighting, and sale of items contained in the pre-approved catalog of products by the host user ID through the creation and augmenting of short-form livestream videos.

The fulfilling component 790 further comprises completing checkout from the virtual purchase cart. In embodiments, the checkout can include charging the customer via the specified payment method (credit card, gift card, cryptocurrency, etc.), and/or processing the order for the product. The completing can also include finalizing a purchase of the product upon conclusion of the short-form video. The flow can also include using a batch order process. In embodiments, when multiple items are purchased via product cards during the playback of a short-form video, the purchases are cached until the termination of the video. The termination of the livestream video can include the user stopping playback, the user exiting the video window, the livestream ending, or a prerecorded video ending. The batch order process can enable a more efficient use of computer resources, such as network bandwidth, by processing the orders together as a batch. Prior to termination of the short-form video, the user can cancel orders that were placed during the playing of the short-form video, which can include clearing/emptying a virtual purchase cart. Thus, embodiments include cancelling a purchase decision for the product within a duration for the short-form video.

The system 700 can include a computer program product embodied in a non-transitory computer readable medium for video editing, the computer program product comprising code which causes one or more processors to perform operations of: creating a micro-website, wherein the micro-website is associated with a user ID; determining a pre-approved electronic catalog of products from a master catalog, wherein the determining is based on the user ID; populating a back end of the micro-website with one or more products for sale from the pre-approved electronic catalog of products, wherein the populating includes an ecommerce linkage; augmenting a short-form video within the micro-website, wherein the augmenting includes highlighting the one or more products for sale; rendering, in response to a user, the short-form video that was augmented, wherein the rendering includes an ecommerce environment; and fulfilling an ecommerce order, wherein the fulfilling is accomplished by the ecommerce linkage.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video editing comprising:
creating a micro-website, wherein the micro-website is associated with a user ID;
determining a pre-approved electronic catalog of products from a master catalog, wherein the determining is based on the user ID;
populating a back end of the micro-website with one or more products for sale from the pre-approved electronic catalog of products, wherein the populating includes an ecommerce linkage;
augmenting a short-form video within the micro-website, wherein the augmenting includes highlighting the one or more products for sale;
rendering, in response to a user, the short-form video that was augmented, wherein the rendering includes an ecommerce environment; and
fulfilling an ecommerce order, wherein the fulfilling is accomplished by the ecommerce linkage.

2. The method of claim 1 wherein the ecommerce linkage includes a price, a shipping price, and a shipping method.

3. The method of claim 1 wherein the rendering includes a product card.

4. The method of claim 1 wherein the short-form video comprises a livestream.

5. The method of claim 4 wherein the user ID is associated with a host of the livestream.

6. The method of claim 1 wherein the user ID corresponds to a social media influencer.

7. The method of claim 6 wherein the determining is based on the social media influencer.

8. The method of claim 6 wherein the determining is based on a number of followers of the social media influencer.

9. The method of claim 1 wherein the user ID corresponds to an expert in a subject matter.

10. The method of claim 1 wherein the user ID corresponds to a celebrity.

11. The method of claim 1 further comprising adding, to the pre-approved electronic catalog of products, additional products from the master catalog.

12. The method of claim 11 wherein the micro-website achieves an engagement metric.

13. The method of claim 1 further comprising selecting, by the user, the one or more products for sale.

14. The method of claim 13 further comprising displaying a product details page in response to a user action.

15. The method of claim 13 further comprising enabling an ecommerce purchase, within the ecommerce environment, of the one or more products that were selected.

16. The method of claim 15 wherein the enabling the ecommerce purchase includes a virtual purchase cart.

17. The method of claim 16 wherein the virtual purchase cart covers a portion of the short-form video.

18. The method of claim 16 wherein the enabling includes an ability for the user to update quantity, price, size, color, or other variable aspects of a product.

19. The method of claim 16 further comprising completing checkout from the virtual purchase cart.

20. The method of claim 1 further comprising managing the micro-website by a mobile application.

21. The method of claim 20 further comprising reporting, by the mobile application, one or more engagement metrics.

22. The method of claim 20 wherein the managing further comprises creating the short-form video.

23. The method of claim 22 wherein the one or more products from the pre-approved electronic catalog are highlighted in the short-form video.

24. The method of claim 23 wherein the short-form video comprises a livestream.

25. A computer program product embodied in a non-transitory computer readable medium for video editing, the computer program product comprising code which causes one or more processors to perform operations of:
creating a micro-website, wherein the micro-website is associated with a user ID;
determining a pre-approved electronic catalog of products from a master catalog, wherein the determining is based on the user ID;
populating a back end of the micro-website with one or more products for sale from the pre-approved electronic catalog of products, wherein the populating includes an ecommerce linkage;
augmenting a short-form video within the micro-website, wherein the augmenting includes highlighting the one or more products for sale;
rendering, in response to a user, the short-form video that was augmented, wherein the rendering includes an ecommerce environment; and
fulfilling an ecommerce order, wherein the fulfilling is accomplished by the ecommerce linkage.

26. A computer system for video editing comprising:
a memory which stores instructions;
one or more processors coupled to the memory wherein the one or more processors, when executing the instructions which are stored, are configured to:
create a micro-website, wherein the micro-website is associated with a user ID;
determine a pre-approved electronic catalog of products from a master catalog, wherein determining is based on the user ID;
populate a back end of the micro-website with one or more products for sale from the pre-approved electronic catalog of products, wherein populating includes an ecommerce linkage;
augment a short-form video within the micro-website, wherein augmenting includes highlighting the one or more products for sale;
render, in response to a user, the short-form video that was augmented, wherein rendering includes an ecommerce environment; and
fulfill an ecommerce order, wherein fulfilling is accomplished by the ecommerce linkage.
